(19) United States
(12) Patent Application Publication
(10) Pub. No.: US 2008/0073017 A1
(43) Pub. Date: Mar. 27, 2008

(54) Run-flat system comprising a foam support ring mounted to a rim by securing strips

(75) Inventors: Martial Fayol, Volvic (FR); Stephanie Mahinc, Clermont-Ferrand (FR); Philippe Tramond, Saint-Ours-Les-Roches (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A.

(21) Appl. No.: 11/790,848

(22) Filed: Apr. 27, 2007

(30) Foreign Application Priority Data
May 5, 2006 (FR) 06/04168

(51) Int. Cl. B60C 17/06

(52) U.S. Cl. 152/520

(57) ABSTRACT

A wheel includes a rim including seats configured to accept the beads of a tire. The tire is intended to be used with a cellular rubber support ring of substantially toroidal shape which allows for running in the deflated state. The rim has a groove, intended to accept the support ring. Each edge of the groove includes a protrusion, wherein the protrusions face axially toward one another. Circumferentially spaced strips are connected to the radially inner surface of the support ring. The ends of each strip include axially spaced spring leaves arranged to engage respective ones of the protrusions for restraining the support ring against radially outward movement under the action of centrifugal force.

The present application claims priority under 35 U.S.C. §119 to Patent Application Serial. No. 06/04168 filed in France on May 5, 2006, the entire content of which is hereby incorporated by reference.

### BACKGROUND

The invention relates to tires, and to running systems able to run at reduced pressure and intended to equip motor vehicles. These systems typically comprise a rim provided with a valve, a tire, and a support ring of approximately toroidal shape disposed in the tire.

This support ring, more commonly known as a foam support ring, is generally made of closed-cell cellular rubber. It is intended to take the load in the event of a loss of tire pressure. The cells may, in some cases, contain a pressurized gas.

When, at the service pressure, it is desirable to prevent the support ring from occupying all the interior space defined by the rim and the tire, it is necessary to keep the sole (internal surface) of the support ring in close contact with the rim in order to contain the effects associated with centrifugal force, the action of which would otherwise tend to press the support ring against the upper interior wall of the tire. This measure proves to be particularly beneficial in extending the life of the support ring.

Hence, numerous technical solutions have been employed and, above and beyond the problems that they are supposed to solve, they also present particular disadvantages.

By way of example, it has been proposed for the sole to be reinforced with reinforcing plies able to keep the interior circumference of the support ring substantially constant. This solution proves to be effective but requires the use of a rim and tire of a special type, such as inverted-seat rims which have different seat diameters, so as to allow the fitting of a tire containing a support ring the circumference of which is fixed to the rim.

Another solution is to create a vacuum under the sole so as to utilize the difference in pressure between the pressure inside the tire and the external pressure to hold the support ring in place under the rim. This solution allows the use of a rim and tire of conventional type, but the suction-cup effect employed nonetheless has the disadvantage of being effective only over a limited range of speeds.

It is an object of the invention to propose a beneficial alternative solution to these known technical solutions while at the same time offering particular advantages associated with its great ease of use.

### SUMMARY OF THE INVENTION

The system according to the invention is formed of a wheel comprising a rim including seats intended to accept the beads of a tire, the tire intended to be used with a cellular rubber support ring of substantially toroidal shape which allows for running in the deflated state.

The rim includes a groove intended to accept the sole of the support ring. The meridian section of the groove has, at each of its edges, protrusions extending substantially in the axial direction and situated radially outwardly of the bottom of the groove.

Connecting strips are positioned axially around the circumference of the sole of the support ring. Each strip includes, at its two ends, a spring leaf the shape of which is designed to cooperate with the rim's protrusion under which the leaf is engaged.

When assembling the tire containing a support ring including strips of the kind described hereinabove on a rim that has suitable protrusions, the spring leaves engage under that part of the protrusion that faces the bottom of the groove so as to prevent any radial outward movements of the strips and of the support ring to which the said strips are connected.

Through a careful choice of the shape of the spring compared with the shape of the protrusion, as will be explained in detail in the description of the preferred embodiments, it is possible to achieve attachment of the sole of the support ring to the bottom of the rim that has the mechanical properties that will allow the system to be used at high speeds.

In addition, as there is free space between two adjacent strips, it is possible to vary the circumference of the support ring, in particular to increase the circumference slightly by exerting reasonable force. This property, which relies on the substantially elastic nature of the support ring, proves particularly advantageous when the seats that are intended to accept the beads of the tire have a diameter greater than the diameter of the bottom of the groove on which the sole of the support ring rests. The support ring can then be mounted on the rim simply by stretching the circumference of the support ring, so as to allow it to slip over the seats of the rim. On releasing the force, the support ring returns to its nominal diameter and the sole is pressed firmly against the bottom of the groove, thereby causing the spring leaves to engage under the protrusions intended to accept them.

In this way, a system is obtained that is easy to assemble and has the mechanical qualities of holding the sole of the support ring against the rim in a way that is able to withstand high-speed running.

### BRIEF DESCRIPTION OF DRAWING

The description which follows relies on the figures that illustrate preferred embodiments of the invention and in which:

FIG. 1 depicts a schematic view in meridian section of a tire comprising a support ring according to the invention,

FIG. 2 depicts a schematic view in meridian section of a tire containing a support ring according to the invention mounted on a rim before the spring leaves have engaged under the protrusions,

FIG. 3 depicts a schematic view in meridian section of the system once the spring leaves have engaged,

FIG. 4 depicts a schematic view in perspective of a support ring according to the invention,

FIG. 5 depicts a schematic view in meridian section of a first embodiment of the spring leaves,

FIG. 6 depicts a schematic view in perspective of the strip corresponding to this first embodiment,

FIG. 7 depicts a schematic view in meridian section of a second embodiment of the spring leaves,

FIGS. 8 and 9 depict two variants of the strips corresponding to this second embodiment of FIG. 7.

### DETAILED DESCRIPTION OF PREFERRED EMBODIMENTS

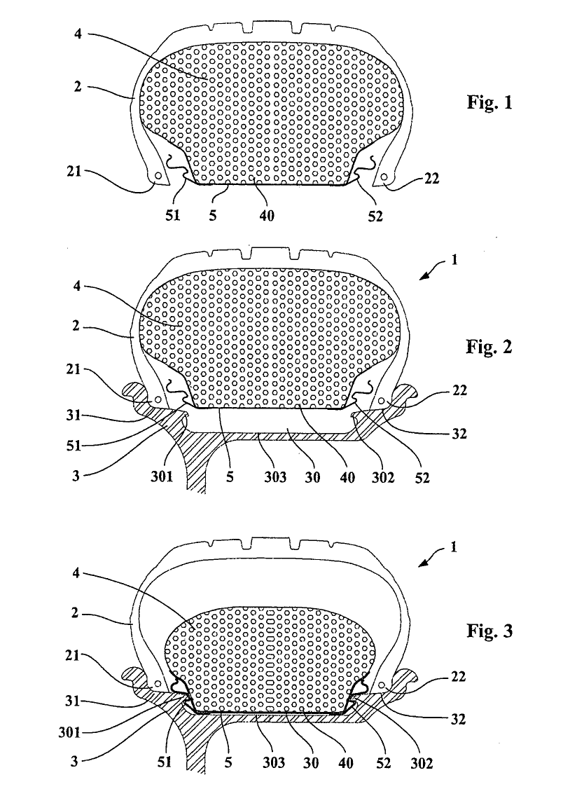

FIG. 1 depicts a foam support ring 4 according to the invention positioned inside a tire 2, comprising beads 21 and 22. A strip 5 is fixed to the sole 40 of the support ring. The strip includes latches in the form of spring leaves 51 and 52 disposed at the two respective ends of the strip 5. The strip 5 comprises one of numerous circumferentially spaced strips attached to the support ring.

FIG. 2 shows the rim 3 on which the seats 31 and 32 intended to accept the beads 21 and 22 of the tire 2 are located. The rim 3 includes a groove 30 positioned between the two seats 31 and 32. The bottom 303 of the groove 30, which is substantially parallel to the axis of rotation of the rim, is configured to accept the sole 40 of the support ring 4. As a preference, the bottom 303 of the groove 30 is positioned at a smaller diameter than the diameter of the seats 31 and 32.

Protrusions 301 and 302 are arranged on each of the edges of the groove 30 radially above the bottom of the groove and extend in a substantially axial direction toward one another. These protrusions 301 and 302 have part of their respective surfaces facing radially inwardly toward the bottom 303 of the groove.

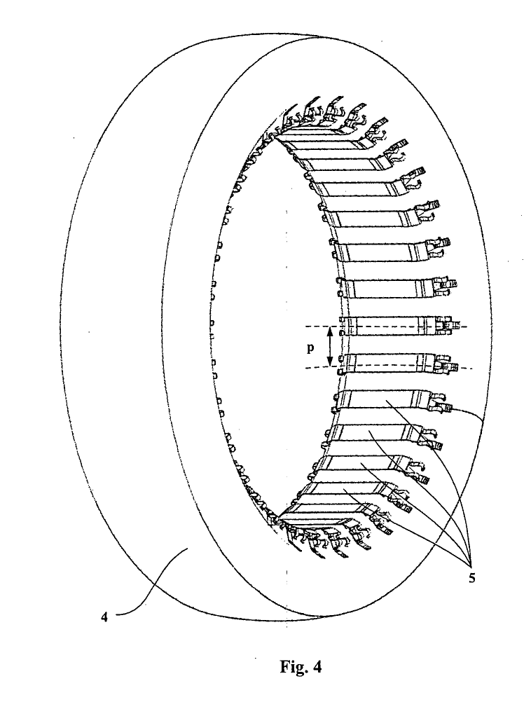

FIG. 3 shows the attachment of the support ring 4 to the rim 3 using the spring leaves 51 and 52 when the sole 40 is placed on the bottom 303 of the groove 30. The spring leaves 51 and 52 engage with the undersides of the protrusions 301 and 302 and rest against that face of the protrusion that faces the bottom 303 of the groove, thereby preventing the strip and the foam support ring from moving in the radial outward direction.

The spring leaves can engage beneath the protrusions 301, 302 under the action of the elastic clamping forces obtained through a suitable choice of interior diameter for the support ring or pressure exerted on the tread strip once assembly has been achieved. It will also be noted that, under the effect of the inflation pressure, the foam support ring will contract, and this also has an effect of pressing the support ring against the rim and of engaging the spring leaves 51 and 52.

Each leaf 51, 52 slips between the sidewall of the support ring and the axially interior edge of the protrusion 301, 302. This operation is made far easier as a result of the elastic nature of the material of which the foam support ring is made. Once this passage has been negotiated, each leaf (51, 52) is then free to move axially outwards to engage with the protrusion 301, 302. The shape of the spring leaf 51 is designed so that the leaf can become lodged in the space between the protrusion 301 and the bottom 303 of the groove 30.

It will also be noted that, in order to increase the tensile strength of the attachment between the foam support ring 4 and the rim 3 in the radial direction, it is beneficial to orientate each spring leaf 51, 52 in a substantially radial direction.

In order to avoid any unwanted disengagement of the spring leaf 51, 52 from its connection with the protrusion, the wall of the lower part of the sidewall of the support ring will block the movements of the spring leaf in the axial direction. This can be accomplished by adapting the geometry of the foam support ring in such a way that the sidewall of the support ring 4 can press against the edge of the protrusion 301, 302 once the spring leaf is engaged with the protrusion.

The materials chosen for making the strip 5 and the spring leaf 51, 52 may be of various kinds. One first embodiment involves using a metal 5 base 5a onto which metal spring leaves 51 and 52 are welded.

It is also possible to make strips 5 from thermoplastic materials the mechanical characteristics of which are able to confer the desired mechanical and elastic properties.

The connection between the sole 40 and the strip 5 may be made by bonding or by inserting the strip in the sole during the moulding of the support ring.

FIG. 4 illustrates a foam support ring 4 according to the invention in which the strips have been positioned circumferentially on the sole and spaced apart by a given circumferential spacing “p”. This spacing is determined according to the number of strips that have to be positioned in order to obtain the desired mechanical strength while at the same time maintaining the circumferential elasticity of the support ring in order to allow for fitting. In practice, a spacing substantially equal to the width of the strip allows the desired compromise to be reached.

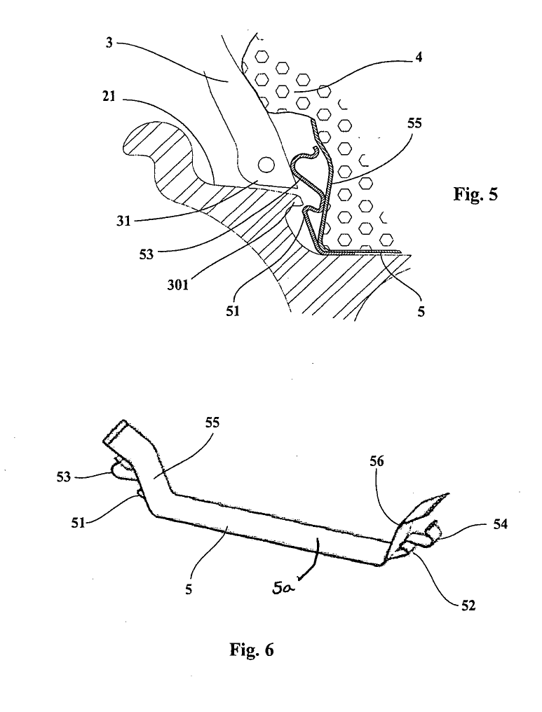

FIGS. 5 to 9 illustrate two particularly advantageous embodiments of the strips.

Specifically, it may prove necessary for the system formed by the tire and the foam support ring to be disassembled, for example, when the foam support ring needs to be replaced after prolonged use in deflated mode.

Still according to the invention, it is proposed for the spring leaves 51, 52 to be equipped with an extension 53, 54 extending each of the leaves 51, 52 in a direction directed substantially radially outwards and placed, in this direction, above radially outwardly of the protrusion 301, 302. The shape of the extension 53, 54 is designed to fit around the protrusion 301, 302 and thus making the spring leaf accessible to be disengaged from the protrusion.

As a preference, the extensions 53, 54 have the overall shape of an S. The lower part of the S, situated radially towards the inside, fits around the protrusion, and the outer part of the S, situated radially towards the outside, is positioned radially outwardly of the protrusion. When the bead 21 exerts thrust in the axial inward direction, the spring leaf 51 disengages from the protrusion 301 and allows the support ring to move in the radial outward direction.

FIGS. 5 and 6 show a first embodiment of the extension 53. It may also be seen that the axial travel needed for the movement of the spring leaf 51, 52 is obtained by compressing the sidewall of the support ring 4.

In this way it is possible to disassemble the system without having to introduce a special tool to detach the support ring 4 from the rim 3.

FIGS. 5 and 6 also shows a particular embodiment of the strip 5 in which embodiment the strip is equipped with lateral reinforcements 55, 56 extending along the lateral wall of the lower part of the sidewall of the support ring 4. These reinforcements have the purpose of, to a certain extent, limiting the radial extension of the support ring when the latter is subjected to the stresses of centrifugal force.

FIG. 6 shows a strip 5 which, at its two ends, has lateral reinforcements 55 and 56 and spring leaves 51 and 52 equipped with an extension 53 and 54.

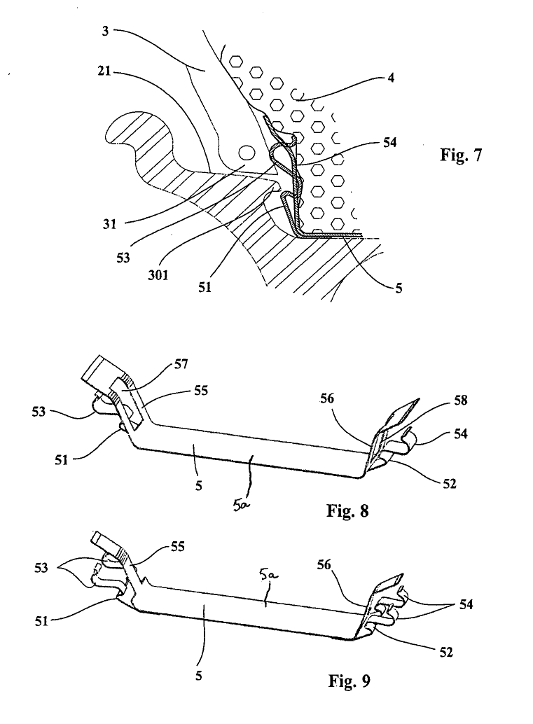

FIGS. 7 to 9 describe another particular embodiment in which the spring leaf is allowed to move freely in the axial direction beyond the surface formed by the lateral reinforcements 55 and 56.

In the configuration described in FIGS. 5 and 6, it can be seen that, when the bead 31 of the tire exerts thrust on the extension 53, the extension bears against the lateral reinforcement 55 in such a way as to deform the sidewall of the support ring 4. However, the thrust that has to be exerted on the extension 53 in order to disengage the spring 51 may, in some cases, be relatively high. This situation occurs when the width of the strip is such that the surface-area of the reinforcement that is in contact with the sidewall of the support ring is high or alternatively, when the elastic properties of the support ring are relatively poor.

This situation may present the operator with some difficulties, or cause degradation of the spring.

Under such conditions, it is proposed that an opening 57, 58 be made in the reinforcement 55, 56, as illustrated in FIG. 8, or alternatively that the spring leaf 51, 52 and its extension 53, 54 be split into two parts. which straddle the reinforcement and are able to move relative to the reinforcement in the axial direction on both sides of the reinforcement 55, as is illustrated in FIG. 9.

In this way, the spring can more easily penetrate the sidewall of the foam support ring axially when the bead 21 acts on the extension 53 to release the spring 51 from the protrusion 301 as is illustrated in FIG. 7.

What is claimed is:

1. A wheel comprising a rim and a cellular foam support ring disposed thereon, the rim including seats configured to receive the beads of a tire and the support ring arranged to support a deflated tire; the rim further including a circumferential groove open in a radial outward direction in which a sole portion of the support ring is disposed, the groove comprising axially spaced edges which include respective protrusions projecting generally axially toward one another and located radially outwardly of a bottom of the groove, the support ring carrying a connecting structure for connecting the support ring to the rim; the connecting structure including latches engageable with respective protrusions such that a portion of each latch engages a radially inwardly facing surface of a respective protrusion to restrain the support ring against radial outward movement.

2. The wheel according to claim 1 wherein the connecting structure comprises a strip which includes a base connected to a radially inner surface of the support ring, two of the latches being attached to respective axially spaced ends of the base, there being a plurality of the strips attached in circumferentially spaced relationship around the radially inner surface.

3. The wheel according to claim 2 wherein the latches constitute spring leaves fixed to the base for elastic flexing relative thereto.

4. The wheel according to claim 3 wherein the bottom of the groove is situated radially inwardly with respect to the seats.

5. The wheel according to claim 4 wherein a radially outer extension of each spring leaf also extends across a radially outwardly facing surface of the respective protrusion, each spring leaf adapted to be disengaged from the respective protrusion in response to a generally axial force applied to the radially outer extension thereof by a respective bead of a tire.

6. The wheel according to claim 5 wherein the base of each strip includes reinforcing portions extending generally radially along respective side portions of the support ring.

7. The wheel according to claim 6 wherein each reinforcing portion includes an opening through which the respective spring leaf can move in a generally radial direction when being disengaged from a protrusion.

8. The wheel according to claim 6 wherein each spring leaf comprises two circumferentially spaced parts which straddle the respective reinforcing portion to be axially movable post the respective reinforcing portion when being disengaged from a protrusion.

9. The wheel according to claim 1 wherein the support ring is formed of cellular rubber.
